(19) United States
(12) Patent Application Publication
(10) Pub. No.: US 2017/0080831 A1
(43) Pub. Date: Mar. 23, 2017

(54) VEHICLE SEAT, IN PARTICULAR MOTOR VEHICLE SEAT

(71) Applicant: JOHNSON CONTROLS COMPONENTS GMBH & CO. KG, Kaiserslautern (DE)

(72) Inventors: Joachim KAEMMERER, Kaiserslautern (DE); Dirk DUBOIS, Hinterweidenthal (DE); Andreas BERBERICH, Kaiserslautern (DE)

(21) Appl. No.: 15/310,960

(22) PCT Filed: May 7, 2015
(86) PCT No.: PCT/EP2015/060052

§ 371 Date: Nov. 14, 2016

(30) Foreign Application Priority Data
May 15, 2014 (DE) 10 2014 209 251.5
Jul. 16, 2014 (DE) 10 2014 213 860.4

(51) Int. Cl. B60N 2/30; B60N 2/36; B60N 2/02

(52) U.S. Cl. CPC B60N 2/3068; B60N 2/305; B60N 2/3011; B60N 2/309; B60N 2/0232; B60N 2/36

(57) ABSTRACT

A vehicle seat (1) is transferable from at least one use position either into an entry position or into a floor position. A seat cushion (3) and a backrest (5) are coupled by a carrier (20) to a base (10), providing kinematics (30, 40, 41, 42, 50, 53, 54) to move the carrier (20) between the use position and the entry position of the vehicle seat (1). A link (80) is coupled rotatably at one end to the seat cushion (3) and at the other end to the base (10). The seat cushion (3) is mounted on the carrier (20) by a turning and sliding joint (16, 26). At least one degree of freedom of the turning and sliding joint (16, 26) is lockable by a locking device (90). A drive, a spring, assists the transfer of the seat cushion (3) from the use position into the floor position.

### CROSS REFERENCE TO RELATED APPLICATIONS

This application is a United States National Phase Application of International Application PCT/EP2015/060052 filed May 7, 2015 and claims the benefit of priority under 35 U.S.C. §119 of German Applications 10 2014 209 251.5 filed May 15, 2014, and 10 2014 213 860.4 filed Jul. 16, 2014, the entire contents of which are incorporated herein by reference.

### FIELD OF THE INVENTION

The invention relates to a vehicle seat, in particular a motor vehicle seat, which is transferable from at least one use position, which is suitable for conveying an individual, either into an entry position or into a floor position, as the non-use position, and back, comprising a seat cushion and a backrest, a carrier to which the seat cushion and the backrest are coupled, a base, kinematics for the articulated connection of the carrier to the base in such a manner that the carrier is movable between a first position of the carrier corresponding to the at least one use position of the vehicle seat, and a second position of the carrier corresponding to the entry position of the vehicle seat, and a rocker which is coupled rotatably at one end to the seat cushion and at the other end to the base, wherein the seat cushion is mounted on the carrier by means of a turning and sliding joint, and at least one degree of freedom of the turning and sliding joint is lockable by a locking device.

### BACKGROUND OF THE INVENTION

WO 02 22391 A1 discloses a vehicle seat, comprising a seat cushion, a backrest and an articulated seat frame with feet which are to be fastened releasably to the vehicle structure, wherein the vehicle seat is adjustable between a use position suitable for conveying an individual and a folded-up package position, wherein, for the transition from the use position into the package position, after the feet present in the region of the backrest are released, the backrest executes an offset movement in the direction of the seat cushion.

EP 1 488 950 A2 discloses a vehicle seat of the type in question, with a use position, an entry position and a floor position. The use position of the vehicle seat serves in a manner known per se for transporting an individual. In the entry position, the vehicle seat, in a predominantly upright arrangement, is offset forward in relation to a use position in order to facilitate access to a rear seat row. In the floor position, a backrest is pivoted forward into a substantially horizontal position on a seat cushion. A rear side of the backrest can thus be used as a loading platform. The vehicle seat comprises a substructure which is to be connected to a vehicle structure, and a central structure which bears a seat cushion and a backrest, wherein the substructure and the central structure form two gear members of a first four bar linkage, and wherein the vehicle seat is transferable from a use position, in which it can be sat on, into an entry position, wherein, for the transfer of the vehicle seat from the use position into the entry position, the four bar linkage freely pivots the vehicle seat as a whole, while the backrest retains its position relative to the central structure.

DE 10 2009 037 816 B3 discloses a vehicle seat, comprising a base which has a front foot, a seat cushion which is in articulated connection by means of a front leg with the front foot, a rear foot which is locked to the base by means of a first locking device in at least one use position suitable for conveying an individual, a link between the front foot and the rear foot, a coupling means between the seat cushion and the rear foot, a backrest supported by the rear foot, and a coupler between the backrest, on the one hand, and the coupling means or the seat cushion, on the other hand, wherein the vehicle seat is transferable from the use position into an entry position by the seat cushion being pivoted upward, after the rear foot is unlocked, and the backrest making an offset movement forward by means of the rear foot, guided by the link, and wherein the vehicle seat is transferable from the use position into a floor position by the backrest pivoting forward and lowering the seat cushion by means of the coupler. The coupler is coupled to the coupling means or the seat cushion by means of a first turning and sliding joint.

### SUMMARY OF THE INVENTION

The invention is based on the problem of improving a vehicle seat of the type mentioned at the beginning, in particular of varying the end positions of the seat cushion in the entry position and in the floor position in comparison to the known prior art. In particular, the vehicle seat is intended to be able to be moved into a construction space available to a limited extent behind a front seat row for easier entry into a seat row arranged behind the vehicle seat. For this purpose, the seat cushion has to be moved in relation to the backrest. A coupler for coupling the movements of backrest, on the one hand, and seat cushion, on the other hand, is intended to be designed as economically as possible in terms of construction space. In particular, the intention is to provide a vehicle seat which is usable even in vehicle interiors having construction space conditions in which vehicle seats having a via a rigid coupler between seat cushion and backrest are scarcely usable. In addition, the intention is for a lowering of the seat cushion to permit a low loading platform level in the floor position.

This problem is solved according to the invention by a vehicle seat which is transferable from at least one use position, which is suitable for conveying an individual, either into an entry position or into a floor position, as the non-use position, and back, comprising a seat cushion and a backrest, a carrier to which the seat cushion and the backrest are coupled, a base, kinematics for the articulated connection of the carrier to the base in such a manner that the carrier is movable between a first position of the carrier corresponding to the at least one use position of the vehicle seat, and a second position of the carrier corresponding to the entry position of the vehicle seat, and a rocker which is coupled rotatably at one end to the seat cushion and at the other end to the base. The seat cushion is mounted on the carrier by means of a turning and sliding joint, and at least one degree of freedom of the turning and sliding joint is lockable by a locking device. A drive, in particular a spring, assists the transfer of the seat cushion from the use position into the floor position. The first position of the carrier preferably also corresponds to the position which the carrier takes up in the floor position. During the transition from the use position into the floor position, the carrier preferably remains positionally fixed with respect to the base in the first position.

Owing to the fact that a drive, in particular a spring, assists the transfer of the seat cushion from the use position into the floor position, the seat cushion in the floor position and in the entry position can take up end positions which are particularly economical in terms of construction space. A rigid coupler between backrest and seat cushion, or a coupler which is coupled at one end to the backrest and at the other end to a coupling means or the seat cushion by means of a turning and sliding joint, can be omitted. The vehicle seat according to the invention is free of a rigid coupler between backrest and seat cushion. When the locking device is unlocked, the drive moves the seat cushion into the floor position. The drive can be a force accumulator. The drive can be a spring. The drive can be an actuator. The drive can be an electric motor. The drive preferably generates a moment about a joint which serves for coupling the seat cushion to the base or to the carrier. The moment preferably acts on a rocker, wherein said rocker has two ends, and a respective joint is provided in the region of said two ends, of which joints one joint forms the coupling of the rocker to the base, in particular to an adapter of the base, and one joint forms the coupling of the rocker to a front end of the seat cushion.

The use position of the vehicle seat, i.e. a use position of the backrest and a use position of the seat cushion, serves in a manner known per se for conveying an individual. In the entry position, the vehicle seat, in a predominantly upright arrangement in relation to a use position, is offset forward in order to facilitate access to a rear seat row. In the floor position of the vehicle seat, the backrest takes up a floor position and the seat cushion takes up a floor position. In the floor position, the backrest is pivoted forward into a substantially horizontal position on the seat cushion. The rear side of the backrest can thus be used as a loading platform. In the floor position of the seat cushion, the seat cushion is preferably shifted forward and lowered. As a result, the seat cushion can be arranged low down in a footwell of the vehicle. The backrest can likewise be arranged lower down and flat in the floor position.

In a preferred embodiment, during the transfer of the vehicle seat from the use position into the floor position, the locking device is unlocked, and therefore the seat cushion is displaceable and rotatable relative to the carrier. As a result, a lower end position of the seat cushion than in the prior art can be achieved.

During the transfer of the vehicle seat from the use position into the entry position, the locking device is preferably locked. Advantageously, precisely one degree of freedom is locked here, namely the displacement of the seat cushion relative to the carrier. However, rotation of the seat cushion relative to the carrier is possible. When the locking device is locked, the bolt can be rotatable in the opening, but cannot be displaced within the opening.

A turning and sliding joint can be constructed in a particularly simple and cost-effective manner by a bolt which is fastened to the seat cushion being guided in an opening, in particular in an elongated hole in the carrier. Alternatively, a bolt which is fastened to the carrier can be guided in an opening, in particular in an elongated hole in the seat cushion.

The carrier is advantageously connected to the base by means of a four bar linkage arrangement. The carrier is in particular connected to the base by means of two links.

In a preferred embodiment, the base comprises a seat rail arrangement. As a result, the vehicle seat can be displaced in and counter to the longitudinal direction, which approximately corresponds to the direction of travel. A vehicle seat which is in the entry position can then be additionally displaced forward, which facilitates access to a rear seat row. However, the invention is not restricted to a seat rail arrangement as the base. The base can be a vehicle structure or can be connected fixedly to a vehicle structure. Adaptor brackets or adaptor plates can serve as the base. The adaptor brackets can be reshaped plates.

The access to a rear seat row is also facilitated if the seat cushion and the backrest have a more upright position in the entry position than in the use position.

The carrier can be connected via a four bar linkage and a first lock to a second seat rail of the base, which seat rail is designed as an upper rail. The first lock can be designed as a rotary latch lock. In order to transfer the vehicle seat from a use position into an entry position (frequently also referred to as easy-entry position), the first lock and a second lock, which acts between the carrier and a rear region of the seat cushion, is opened. The second lock can be designed as a rotary latch lock. The four bar linkage pivots the carrier forward and upward such that, in the entry position, the carrier is preferably in a position which is more upright by approximately 30° in relation to the use position. In addition, the seat cushion, driven via the carrier or a frame having the carrier, or via a spring, preferably pivots into a substantially upright position.

A rocker which connects the front region of the seat cushion to the second seat rail has two functions. Firstly, during the transfer of the vehicle seat into the entry position, the rocker brings about a pivoting movement of the seat cushion forward. Secondly, the rocker brings about a lowering of the cushion during the transfer of the vehicle seat into the floor position. The four bar linkage can be mounted both rigidly on the vehicle and on a pair of seat rails. A drive for the front rocker, which drive in particular assists the transfer of the seat cushion from the use position into the floor position, can be arranged in the region of the lower hinge point of the rocker (fifth joint) or else in the upper hinge point (sixth joint). A drive in the turning and sliding joint, which is designed as a slotted guide mechanism, is likewise possible. The drive can be a spring.

During the transition from the floor position into the use position, the backrest is preferably first of all pivoted back. The seat cushion can subsequently be pivoted manually into the use position. Alternatively, the seat cushion and the backrest can be coupled to the seat cushion by means of a flexurally soft tension means in such a manner that, during the transition from the floor position into the use position, the movement of the seat cushion is coupled, in particular only from an intermediate position, to the movement of the backrest by means of the flexurally soft tension means. The flexurally soft tension means can be a cable pull or a Bowden cable. Such a flexurally soft coupling can be placed economically in terms of construction space in comparison to a coupler known from the prior art, without having a negative influence on the design.

A cable pull device can couple the locking device to the backrest in such a manner that a pivoting of the backrest forward about a backrest pivot axis brings about an unlocking of the locking device from a defined pivot angle. As a result, from a defined pivot angle of the backrest, the seat cushion is relatively movable with respect to the carrier and is pivoted by the drive into the floor position. In comparison to the prior art, the advantage is afforded that the seat cushion does not have to be driven by a rigid coupling between backrest and seat cushion.

The locking device can alternatively also be triggered by means of an operating lever. The operating lever can also serve for unlocking the backrest or can be coupled to a further operating lever for unlocking the backrest.

The seat cushion can be lockable to the carrier by means of a second locking device designed as a (second) lock. A second lock can be effectively arranged between the carrier and in particular a rear region of the seat cushion. The second lock increases the stability and rigidity of the arrangement of the seat cushion.

The backrest is preferably adjustable in its inclination by means of at least one fitting, in particular two fittings. This increases the seat comfort by the inclination being able to be adapted to the ergonomic needs of the occupant. The omission of a rigid coupling between backrest and seat cushion also permits a lying position. For this purpose, the backrest is pivoted rearward until the backrest takes up a substantially flat lying position. In the case of vehicle seats which are known from the prior art and have a rigid coupler between backrest and seat cushion, a lying position cannot be effectively realized since the coupler can project into the lying surface or would be arranged in the vicinity of the lying surface and therefore disadvantageously influences the lying comfort. By means of the drive which assists the transfer of the seat cushion from the use position into the floor position, a rigid coupler can be omitted and a comfortable flat lying surface can be produced.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a vehicle seat according to the invention in a use position;

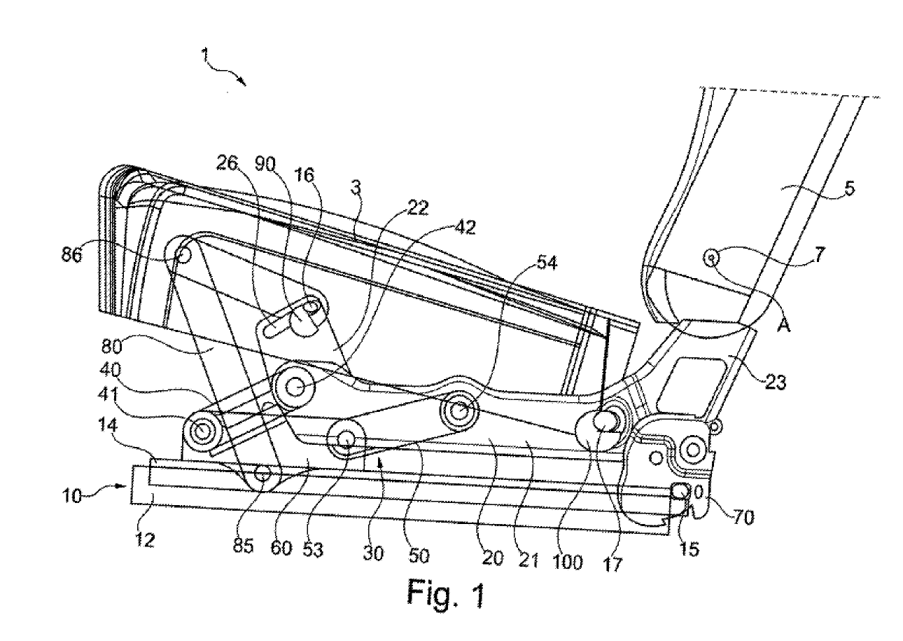

FIG. 2 is a schematic side view of the vehicle seat from FIG. 1, during the transition into an entry position;

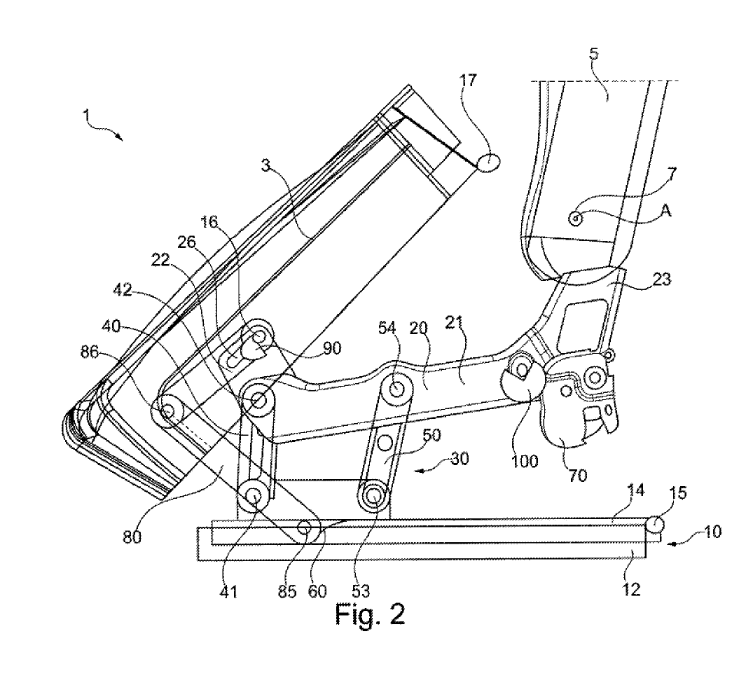

FIG. 3 is a schematic side view of the vehicle seat from FIG. 1 in the entry position; and

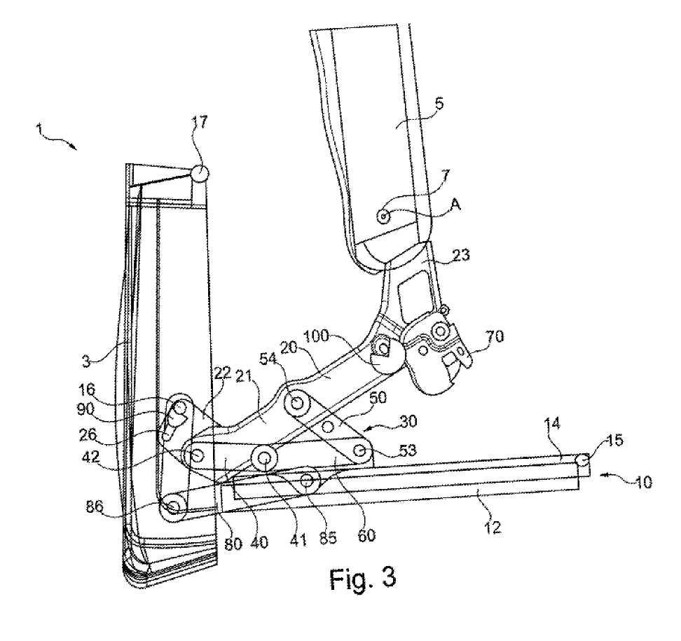

FIG. 4 is a schematic side view of the vehicle seat from FIG. 1 in a floor position.

### DESCRIPTION OF THE PREFERRED EMBODIMENTS

Referring to the drawings, a vehicle seat 1, which is provided, for example, as an outer seat of a middle or rear seat row of a motor vehicle, for example a van, has a seat cushion 3 and a backrest 5. It is assumed in the directional details used below that the vehicle seat 1 is arranged in the motor vehicle in the forward direction of travel, wherein, in a use position of the vehicle seat 1 that is suitable for conveying an individual, the backrest 5 is located at the rear end of the seat cushion 3. The backrest 5 is adjustable in its inclination by means of at least one fitting 7, in the present case two fittings 7, and therefore a plurality of use positions are defined. The two fittings 7 are designed as latching fittings which are known per se, as are known, for example, in WO 2007/039002 A2, but, in particular in the case of an electrified vehicle seat, could also be geared fittings, as are known, for example, from WO 01/12461 A1. The term seat cushion 3 is intended to be understood as meaning the entire assembly consisting of a supporting structure, in the present case a seat cushion carrier, and a covered pad. To the extent that components are coupled to the seat cushion 3, this should be understood as meaning a coupling to the supporting structure of the seat cushion 3. The same applies to the backrest 5.

For the sake of simplicity, in the following, only the left vehicle seat side of the vehicle seat 1, which is substantially symmetrical with respect to a plane running in the direction of travel and vertically, is described, i.e. the components mentioned below, unless described differently, are present in duplicate (optionally mirror-symmetrically). The vehicle seat 1 is first of all described in a special use position, namely the design position, in which the backrest 5 is inclined slightly to the rear, in the present case by approximately 22°, in relation to the vertical. A base 10 of the vehicle seat 1 is connected to the structure of the motor vehicle, for example to the floor of the vehicle body.

In the exemplary embodiment, the base 10 is designed as a seat rail arrangement which opens up the possibility of a longitudinal adjustment of the vehicle seat 1. In the present case, the base 10 has a first seat rail 12 which is connected directly to the vehicle structure, and a second seat rail 14 which is displaceable in the longitudinal direction relative to said first seat rail. The two seat rails 12 and 14, which have a substantially U-shaped profile, engage one behind the other in an alternating manner by their inwardly and outwardly curved longitudinal edges and are lockable to each other—by means of a rail lock which is known per se.

A carrier 20 is coupled to the base 10. The carrier 20 has a U-shaped design with a first carrier portion 21 running approximately in the direction of travel, a second carrier portion 22 which is angled forward and obliquely upward in the front region of the first carrier portion 21, and a third carrier portion 23 which is angled rearward and obliquely upward in the rear region of the first carrier portion 21. In its upper region, the second carrier portion 22 has an elongated hole 26 which, in the use position of the vehicle seat 1, runs forward and downward by approximately 35° in relation to the direction.

The carrier 20 is coupled, in particular in a front region, to the base 10, in the present case to an adaptor 60 of the second seat rail 14, by means of a four bar linkage 30. The four bar linkage 30 comprises a first link 40 and a second link 50 arranged behind the first link 40 in the direction of travel, which links each have a joint 41, 42, 53, 54 in the regions of the two link ends. A first joint 41 connects the first link 40 to the adaptor 60 fastened to the second seat rail 14. A second joint 42 connects the first link 40 to the carrier 20, a third link 53 connects the second link 50 to the adaptor 60 and a fourth link 54 connects the second link 50 to the carrier 20. The carrier 20 is therefore connected in an articulated manner to the adaptor 60 of the base 10 by means of the links 40 and 50.

The carrier 20 is additionally lockable in its rear region by means of a first lock 70 in a releasable manner to the base 10, more precisely to a counter element which is mounted on the base, in the present case a first bolt 15 fastened to the second seat rail 14, and is therefore indirectly connected to the vehicle structure. The first lock 70 is designed as a rotary latch lock which is known per se, as is known, for example, from WO 2004/069580 A2.

A first fitting part of the fitting 7 is attached to the third carrier portion 23 of the carrier 20, while a second fitting part of the fitting 7, which fitting part is pivotable about a backrest pivot axis A relative to the first fitting part and is lockable thereto, is fastened to the backrest 5. The backrest 5 is adjustable in its inclination relative to the carrier 20 by means of the fitting 7. The backrest pivot axis A runs horizontally between the two vehicle seat sides and can be designed as a transmission rod which runs between the fittings 7 present on both sides and couples the locking state of said fittings to each other. When the backrest 5 is adjusted in inclination, the fitting 7 on each vehicle seat side is unlocked, the backrest 5 is pivoted about the backrest pivot axis A into the desired position and then each fitting 7 is locked again. The backrest 5 can optionally also be pivoted rearward in a substantially flat manner such that the vehicle seat 1 takes up a lying position.

The seat cushion 3 is coupled to the adaptor 60 by means of a rocker 80, wherein said rocker 80 has two ends, and a respective joint 85, 86 is provided in the region of said two ends, of which joints a fifth joint 85 forms the coupling of the rocker 80 to the adaptor 60 and a sixth joint 86 forms the coupling of the rocker 80 to the front end of the seat cushion 3. The fifth joint 85 is arranged between the first joint 41 and the third joint 53, as seen in the direction of travel.

A second bolt 16 protrudes laterally from the seat cushion 3 and reaches into the elongated hole 26 of the second carrier portion 22 of the carrier 20. The elongated hole 26 forms a slotted guide mechanism for the second bolt 16, and therefore the seat cushion 3 is mounted rotatably and to a limited extent displaceably with respect to the carrier 20. The elongated hole 26 and the second bolt 16 form a turning and sliding joint. The turning and sliding joint 16, 26 has two degrees of freedom. A first degree of freedom permits rotation of the second bolt 16, and a second degree of freedom permits displacement of the second bolt 16 in the elongated hole 26. A locking device 90 serves for locking the position of the second bolt 16 relative to the elongated hole 26, to be precise in a position in which the second bolt 16 is located in the rear upper end region of the elongated hole 26. As a result, the turning and sliding joint 16, 26 is lockable to form a pure turning joint. The degree of freedom of the displacement of the second bolt 16 in the elongated hole 26 can be blocked by the locking device 90.

A third bolt 17 is fastened to the seat cushion 3 in the rear region thereof. A second lock 100 fastened to the carrier 20 serves in the use position for downwardly supporting the third bolt 17 on the carrier 20 and for locking the third bolt 17. The second lock 100 can be designed as a rotary latch lock. The third bolt 17 cannot be moved forward when the second lock 100 is locked. Locking of the third bolt 17 upward in the vertical direction can optionally be provided. The second lock 100 therefore locks the seat cushion 3 to the carrier 20 at least in a substantially horizontal direction. In a modification of the exemplary embodiment, the second lock 100 is omitted and can be replaced by a support for the third bolt 17.

A first cable pull device (not illustrated in the figures) couples the locking device 90 to the backrest 5 in such a manner that a pivoting of the backrest 5 forward about the backrest pivot axis A, from a defined pivot angle, brings about an unlocking of the locking device 90 such that the second bolt 16 is freely movable within the elongated hole 26.

A second cable pull device (not illustrated in the figures) couples the second lock 100 to the backrest 5 in such a manner that a pivoting of the backrest 5 forward about the backrest pivot axis A, from a defined pivot angle, brings about an unlocking of the second lock 100 such that the third bolt 17 is unlocked and the seat cushion 3 is movable relative to the carrier 20. In addition, the second lock 100 is coupled in such a manner to an operating element (not illustrated in the figures) for unlocking the first lock 70 that an unlocking of the first lock 70 also brings about an unlocking of the second lock 100. Such a coupling between the first lock 70 and the second lock 100 can be omitted if the second lock 100 in the locked state does not secure the third bolt 17 and therefore the seat cushion 3 in the vertical direction.

For the transfer of the vehicle seat 1 from the use position into an entry position as an excellent non-use position, the first lock 70 and therefore also the second lock 100 are unlocked. The fitting 7 and the locking device 90 each remain locked. The carrier 20 is now offset forward in relation to the base 10 by means of the four bar linkage 30, i.e. by means of the two links 40, 50. The carrier 20 moves as a result from a first position of the carrier 20 into a second position of the carrier 20. The pivoting movements of the links 40, 50 cause the carrier 20 to be moved upward and forward relative to the base 10, as a result of which said carrier moves away from the base 10. As a result, the backrest 5 is in a rigid arrangement relative to the carrier 20, but pivots upward and forward as a whole. In accordance with the described movement of the carrier 20, the second bolt 16, which is locked in the elongated hole 26, also moves together with the carrier 20. The rocker 80 is thereby pivoted forward and the seat cushion 3 rotates about the second bolt 16, the relative position of which with respect to the second carrier portion 22 remains unchanged, but which rotates relative to the carrier 20. In the entry position, the seat cushion 3 is thereby in a position which is more upright and is arranged further forward in comparison to the use position.

During the transition from the use position into the entry position, the locking of the seat rails 12 and 14 is unlocked in a force-controlled manner, in a modification of the exemplary embodiment, and therefore the second seat rail 14 is movable forward, which additionally increases the space behind the vehicle seat 1, i.e. the entry size, and facilitates the access.

When the entry position is reached in which the access to a rear seat row is facilitated, one of the locks 70, 100 or an additional locking device can optionally secure the entry position.

The return into the previously adopted use position takes place by the carrier 20 being pivoted back into a position corresponding to the use position by a pull on the backrest 5 counter to the direction of travel, and therefore the first lock 70 is locked again to the first bolt 15. The seat cushion 3 is likewise pivoted back into the use position on account of its coupling to the carrier 20. As far as the described modification of the exemplary embodiment with an additional longitudinal displacement is concerned, after the first lock 70 is locked, the vehicle seat 1 is pushed back again, by movement of the second seat rail 14, into its longitudinal position corresponding to the use position and the rail lock is locked again.

By means of a comparison between the use position and the entry position, a virtual replacement pivot point for the four bar linkage 30 can be defined. If the carrier 20 were coupled to the base 10 or the vehicle structure in said virtual replacement pivot point, a pivoting movement of the vehicle seat 1 about said virtual replacement pivot point would have the same starting and end position as when the four bar linkage 30 is used. However, in the solution according to the invention, the virtual replacement pivot point lies significantly below the base 10, and therefore cannot be realized. The desired entry size (i.e. the dimensions of the accessible space behind the vehicle seat 1 in the entry position) could not be achieved with a direct coupling of the carrier 20 to the base 10. Better utilization of the pivoting angle range therefore takes place with the four bar linkage 30.

For the transfer of the vehicle seat 1 from the use position into a floor position as a further excellent non-use position in which an increased loading space is available, the backrest 5 is folded forward after the fittings 7 are unlocked. As a result, the locking device 90 and the second lock 100 unlock. The first lock 70 and the rail lock remain locked.

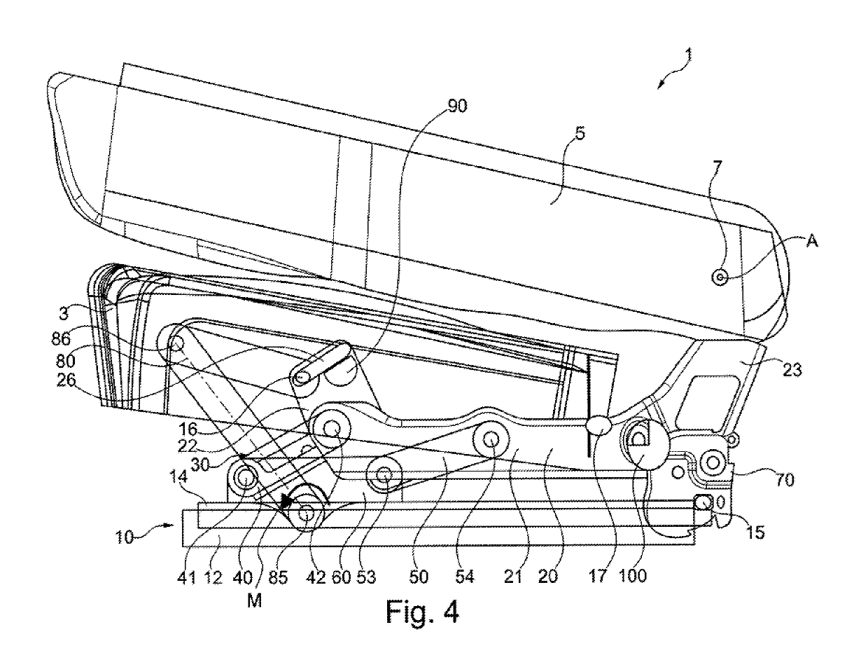

A spring (not illustrated in the figures) which preferably acts in the region of the fifth joint 85 between the rocker 80 and the adaptor 60 pretensions the rocker 80 in such a manner that, when the locking device 90 is opened and the second lock 100 is opened, the third bolt 17 of the seat cushion 3 leaves the opened second lock 100 and the seat cushion 3 is shifted forward. The spring therefore serves as a drive which assists the transfer of the seat cushion 3 from the use position into the floor position. A moment M produced by the spring is depicted in FIG. 4 as a curved arrow about the fifth joint. The rocker 80 pivots forward here about the fifth joint 85, and the second bolt 16 moves forward and downward within the elongated hole 26. As a result, the seat cushion 3 is shifted forward and lowered.

With the approach to the floor position, in which the rear side of the backrest 5 is at least approximately situated in the horizontal, the backrest 5 is placed onto the seat cushion 3. The four bar linkage 30 remains unmoved during the transfer of the vehicle seat 1 into the floor position.

The folded-up floor position is secured by locking of the fitting 7. Alternatively or additionally, the locking device 90 or an additional locking device can secure the floor position.

The return from the floor position into the use position takes place by first of all, after the fittings 7 are unlocked, the backrest 5 being pivoted back into a position corresponding to the use position. The seat cushion 3 is subsequently moved back manually into the position corresponding to the use position by prestressing of the previously described spring. In a modification of the exemplary embodiment, the backrest 5 is coupled to the seat cushion 3 via a cable pull in such a manner that a pivoting back of the backrest 5 causes the seat cushion 3 to be automatically moved back into the position corresponding to the use position.

The features disclosed in the above description, the claims and the drawings may be of importance both individually and in combination for realizing the invention in its various refinements.

While specific embodiments of the invention have been shown and described in detail to illustrate the application of the principles of the invention, it will be understood that the invention may be embodied otherwise without departing from such principles.

1. A vehicle seat, which is transferable from at least one use position, which is suitable for conveying an individual, either into an entry position or into a floor position, as the non-use position, and back, the vehicle seat comprising:
a seat cushion;
a backrest;
a carrier to which the seat cushion and the backrest are coupled;
a base;
an articulated connection of the carrier to the base such that the carrier is movable between a first position of the carrier corresponding to the at least one use position of the vehicle seat (1), and a second position of the carrier corresponding to the entry position of the vehicle seat;
a rocker which is coupled rotatably at one end to the seat cushion and at another end to the base;
a turning and sliding joint, wherein the seat cushion is mounted on the carrier by means of the turning and sliding joint;
a locking device, wherein at least one degree of freedom of the turning and sliding joint is lockable by the locking device; and
a drive, comprising a spring, assisting a transfer of the seat cushion from the use position into the floor position.

2. The vehicle seat as claimed in claim 1, wherein, during the transfer of the vehicle seat from the use position into the floor position, the locking device is unlocked.

3. The vehicle seat as claimed in claim 1, wherein, during a transfer of the vehicle seat from the use position into the entry position, the locking device is locked.

4. The vehicle seat as claimed in claim 1, wherein the turning and sliding joint comprises a bolt which is fastened to the seat cushion and is guided in an opening comprised of an elongated hole, in the carrier.

5. The vehicle seat as claimed in claim 4, wherein, when the locking device is locked, the bolt is rotatable in the opening but cannot be displaced within the opening.

6. The vehicle seat as claimed in claim 1, wherein the articulated connection of the carrier to the base comprises a four bar linkage arrangement.

7. The vehicle seat as claimed in claim 6, wherein the articulated connection of the carrier to the base comprises two links.

8. The vehicle seat as claimed in claim 1, wherein the base comprises a seat rail arrangement.

9. The vehicle seat as claimed in claim 1, wherein the base is a vehicle structure or is fixedly connected to a vehicle structure.

10. The vehicle seat as claimed in claim 1, wherein the seat cushion and the backrest have a more upright position in the entry position than in the use position.

11. The vehicle seat as claimed in claim 1, wherein, in order to transfer the vehicle seat from the use position into the floor position, the backrest is folded forward and the seat cushion is shifted forward and lowered.

12. The vehicle seat as claimed in claim 1, wherein a cable pull device couples the locking device to the backrest such that a pivoting of the backrest forward about a backrest pivot axis brings about an unlocking of the locking device from a defined pivot angle.

13. The vehicle seat as claimed in claim 1, further comprising a second lock effectively arranged between the carrier and a rear region of the seat cushion.

14. The vehicle seat as claimed in claim 1, further comprising fittings, wherein the backrest is adjustable in inclination via the fittings.

15. The vehicle seat as claimed in claim 1, wherein the backrest can be pivoted rearward such that the vehicle seat takes up a lying position.
